(19) United States
(12) Patent Application Publication
(10) Pub. No.: US 2014/0012506 A1
(43) Pub. Date: Jan. 9, 2014

(54) Method and System for Measuring and Calculating a Modified Equivalent Circulating Density (ECDm) in Drilling Operations

(71) Applicant: Rhys Kevin Adsit, Springville, UT (US)

(72) Inventor: Rhys Kevin Adsit, Springville, UT (US)

(73) Assignee: INTELLISERV, LLC, Houston, TX (US)

(21) Appl. No.: 13/542,366

(22) Filed: Jul. 5, 2012

(51) Int. Cl. G01V 3/18; G06F 19/00

(52) U.S. Cl. 702/6

(57) ABSTRACT

A method for collecting and analyzing downhole pressure data includes disposing a plurality of pressure sensors at axially spaced locations along a drill string disposed in a well. A first data set that includes a data point for each of the pressure sensors is collected. Each data point includes a pressure value and a depth value. A value of modified equivalent circulating density (ECDm) is calculated for at least one data point. ECDm includes a static pressure component and a dynamic pressure component. Calculating the ECDm includes computing the static pressure component based on the true vertical depth of the pressure sensor, and computing the dynamic pressure component based on a second depth value that differs from the true vertical depth and is common to all the pressure sensors for which ECDm is calculated.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of the Disclosure

This disclosure relates generally to measuring and calculating borehole condition values for a well. More particularly, the disclosure relates to evaluating properties associated with the fluids in a borehole, including the drilling mud. Still more particularly, it relates to collecting and evaluating pressure measurements related to well operations.

2. Background Information

During the drilling of exploratory boreholes and the drilling and completing of oil and gas wells, a fluid, i.e. drilling mud, is pumped into the borehole of a well to remove cuttings and to maintain pressure along the borehole to inhibit or reduce the intrusion of formation fluids. At the same time, excess mud pressure can increase the loss of drilling mud into the formation and increase the potential for unwanted fracturing of the formation. Therefore, during drilling operations, it may be advantageous to measure and evaluate physical properties within the resulting borehole, including temperature, fluid pressure, borehole size, and borehole shape. In particular, knowledge of the fluid pressure within the annular space existing between the drill string and the borehole well is useful for understanding well behavior and for controlling fluid exchange with the surrounding formation.

Pressures are measured at various locations along the drill string and therefore at differing depths below the surface of the earth. While pumping mud, pressures at differing depths are distinguished by measurable differences in hydrostatic and frictional factors. There is a need in the art for methods for systematically comparing the differing pressures from differing depths in order to more easily and more consistently predict well behavior related to well drilling operations. The art would be advanced if an improved method of normalizing, i.e. scaling, pressure data were developed.

### BRIEF SUMMARY OF THE DISCLOSURE

A method and apparatus for analyzing downhole pressure are disclosed herein. In one embodiment, a method for collecting and analyzing downhole pressure data includes disposing a plurality of pressure sensors at axially spaced locations along a drill string. The drill string is disposed in a well. A first data set that includes a data point for each of the plurality of pressure sensors is collected. Each data point includes a retained pressure value and a corresponding depth value. A value of modified equivalent circulating density (ECDm) is calculated for at least one of the data points. The ECDm includes a static pressure component and a dynamic pressure component. Calculating the ECDm includes computing the static pressure component of the ECDm based on a first depth value, and computing the dynamic pressure component of the ECDm based on a selected depth value that differs from the first depth value.

In another embodiment, a system for analyzing downhole pressure includes a drill string and a drilling control system. The drill string includes a plurality of joints of wired drill pipe arranged end-to-end, and a plurality of pressure sensors spaced along a longitudinal axis of the drill string. The drilling control system is coupled to the pressure sensors via the wired drill pipe. The drilling control system is configured to acquire a first measurement of borehole pressure from each of the pressure sensors and a first depth value corresponding to the depth of the first measurement of the borehole pressure. The drilling control system is also configured to compute a first dynamic pressure component of ECDm for each of the pressure sensors based on a same depth value. The drilling control system is further configured to compute a first ECDm value for each of the pressure sensors based on the first dynamic pressure component computed for the pressure sensor.

In a further embodiment, apparatus for monitoring borehole pressure includes a plurality of pressure sensors, a processor, and borehole condition monitoring instructions: The pressure sensors are distributed over a length of a wired tubular system for measuring borehole annular pressure. The processor is coupled to the wired tubular system. The borehole condition monitoring instructions, when executed by the processor cause the processor to compute a static pressure component for each of the pressure sensors based on a pressure value and a first depth value corresponding to the pressure sensor. The borehole condition monitoring instructions also cause the processor to compute a dynamic pressure component for each of the pressure sensors based on a pressure value corresponding to the pressure sensor and a same depth value applied to all of the pressure sensors. The borehole condition monitoring instructions further cause the processor to compute a first ECDm value for each of the pressure sensors by summation of the static pressure component and the dynamic pressure component corresponding to the pressure sensor.

In still another embodiment, a non-transitory, computer-readable storage device includes storing software that, when executed by a processor, causes the processor to acquire a plurality of data points such that each data point corresponds to a location in a borehole, and each data point includes a pressure value and a corresponding depth value. The software further causes the processor to compute a dynamic pressure component of modified equivalent circulating density for each of the data points based on a selected depth value.

Thus, embodiments described herein comprise a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the disclosed embodiments of the invention, reference will now be made to the accompanying drawings in which:

FIG. 1 is an elevation view in partial cross-section showing a system for drilling a borehole in accordance with principles disclosed herein;

FIG. 2 shows a block diagram of a drilling control system for the drilling system of FIG. 1;

FIG. 3 is an elevation view in partial cross-section illustrating a portion of the drilling system of FIG. 1 disposed in a borehole; and

FIG. 4 is simplified flow diagram of an embodiment of a method for calculating modified equivalent circulating density in accordance with principles disclosed herein.

### DETAILED DESCRIPTION OF THE DISCLOSED EMBODIMENTS

The following description is exemplary of embodiments of the invention. These embodiments are not to be interpreted or otherwise used as limiting the scope of the disclosure, including the claims. One skilled in the art will understand that the following description has broad application, and the discussion of any embodiment is meant only to be exemplary of that embodiment, and is not intended to suggest in any way that the scope of the disclosure, including the claims, is limited to that embodiment.

The drawing figures are not necessarily to scale. Certain features and components disclosed herein may be shown exaggerated in scale or in somewhat schematic form, and some details of conventional elements may not be shown in the interest of clarity and conciseness. In some of the figures, in order to improve clarity and conciseness of the figure, one or more components or aspects of a component may be not depicted or may not have reference numerals identifying the features or components that are identified elsewhere.

The terms “including” and “comprising” are used herein, including in the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections. In addition, if the connection transfers electrical power or signals, whether analog or digital, the coupling may comprise wires or a mode of wireless electromagnetic transmission, for example, radio frequency, microwave, optical, or another mode. So too, the coupling may comprise a magnetic coupling or any other mode of transfer known in the art, or the coupling may comprise a combination of any of these modes. The recitation “based on” is intended to mean “based at least in part on.” Therefore, if X is based on Y, X may be based on Y and any number of other factors.

In addition, as used herein, including in the claims, the terms “axial” and “axially” generally mean along or parallel to a given axis (e.g., central axis of a body or a port), while the terms “radial” and “radially” generally mean perpendicular to the axis. For instance, an axial distance refers to a distance measured along or parallel to the axis, and a radial distance means a distance measured perpendicular to the axis. Any reference to up or down in the description and the claims will be made for purpose of clarification, with “up”, “upper”, “upwardly” or “upstream” meaning toward the surface of the well and with “down”, “lower”, “downwardly” or “downstream” meaning toward the terminal end of the well, regardless of the borehole orientation.

Furthermore, in the disclosure and in the claims, the following definitions will apply.

The term data will refer to information that describes one or more aspect of the operation or the sensing accomplished by a piece of equipment, including instruments. In its various forms, data includes, for example, information about one or more of the following elements: acceleration, density, depth below the earth's surface, specific weight, velocity, rotation, position, pressure, temperature, time, vibration, calibration, and diagnostics. Data will refer to analog information, to digital information, or to both. For example, data can include an analog signal from a pressure transducer, and/or a scaled, digitized signal evaluated from the analog pressure data. Data may be acquired or collected by various means, including measurement, calculation, estimation, simulation, electronic retrieval, and any other suitable method.

Fluid refers to a liquid, a gas, or mixture of both liquid and gas. The liquid and gas may comprise the same substance or may comprise two or more different substances. In some embodiments, such as a drilling mud, for example, a fluid may comprise a mixed slurry of a liquid and/or gas along with suspended or dissolved solids.

### Implementation of Disclosed Embodiments

Disclosed are a method and a system for evaluating, controlling, or simulating the operation of a well, for example controlling a drilling rig while forming a borehole. The method is applicable for at least these types of well operations: drilling, reaming, circulating, tripping, and responding to a stuck pipe. In at least one embodiment, various sensors associated with the drilling rig, including multiple pressure sensors disposed along a drill string, provide data about the well's behavior and rig performance. Pressure in a borehole results at least in part from the presence of a drilling mud and/or formation fluids. The method provides an improved means for normalizing, i.e. scaling, pressure data taken from various depths in the borehole. As will be described, the pressure data, the normalized pressure data, and the data from other sensors can be used to monitor and control drilling operations.

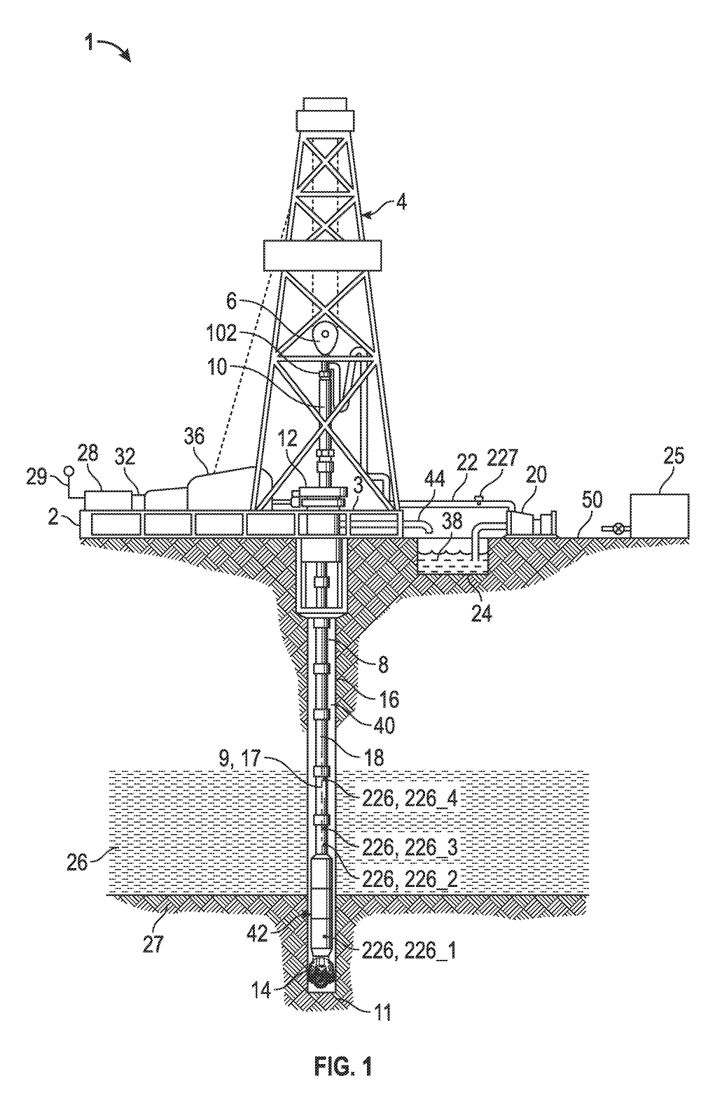

FIG. 1 is a schematic diagram showing an embodiment of a drilling system in accordance with the principles described herein. The drilling system 1 includes derrick 4 supported by a drilling platform 2. The derrick 4 includes a traveling block 6 for raising and lowering a drill string 8. Platform 2 includes a floor 3 and supports a rotary table 12 selectively rotated by a prime mover such as an electric motor controlled by a motor controller. A kelly 10 supports the drill String 8 as it is lowered through the rotary table 12. Although FIG. 1 shows a land-based drilling system; the present disclosure is equally applicable to off-shore well drilling systems.

The drill string 8 extends downward through the rotary table 12. Drill string 8 comprises a longitudinal axis 9 and various components, including one or more pieces of drill pipe 18 and the components of the bottom hole assembly (BHA) 42 (e.g., drill bit 14, mud motor, drill collar, tools, etc.). In FIG. 1, drill pipe 18 is wired drill pipe. A wired drill pipe is one having a conductor or conductors extending from one end of the drill pipe to the other and adapted to couple to the adjacent drill pipe so as to facilitate transfer of data, including control signals, between downhole instruments or equipment and surface equipment, such as control system 28. Examples of a wired drill pipe were described in U.S. Pat. Nos. 7,041,908 and 7,190,280, the entire disclosure of each being hereby incorporated herein by this reference. It will be understood that drill string 8 can comprise other forms of conveyance, such pipe that is not wired drill pipe. The drill bit 14 is attached to and forms the distal end of the drill string 8. The drill bit 14 disintegrates subsurface formations when it is rotated with weight-on-bit to drill the borehole 16, which may also be called a well bore. Borehole 16 comprises a generalized centerline axis 17 and may pass through multiple subsurface formations or zones 26, 27. An annular space 40 exists between the borehole 16 and the drill string 8. The weight-on-bit, which impacts the rate of penetration of the bit 14 through the formations 26, 27, is controlled by a drawworks 36, which includes a motor and a motor controller. In some embodiments of the drilling system 1, a top-drive may be used to rotate the drill string 8 rather than rotation by the rotary table 12 and the kelly 10. In some applications, a downhole motor (mud motor) is disposed in the drilling string 8 to rotate the drill bit 14 in lieu of or in addition to rotating the drill string 8 from the surface. The mud motor rotates the drill bit 14 when drilling fluid passes through the mud motor under pressure.

Referring still to FIG. 1, in many drilling operations, the borehole 8 penetrates a subsurface formation, zone, or reservoir, such as reservoir 11 in subsurface formation 27 that is believed to contain hydrocarbons in a commercially viable quantity. During drilling operations a suitable drilling fluid, hereafter called mud or drilling mud 38, from a first mud tank 24 is circulated under pressure through the drill string 8 by a mud pump 20. The mud 38 passes from the mud pump 20 into the drill string 8 via fluid line 22 and the kelly 10. The mud 38 is discharged at the borehole bottom through nozzles in the drill bit 14. The mud 38 circulates to the surface through the annular space 40 between the drill string 8 and the sidewall of borehole 16, and returns to the mud tank 24 via a solids control system (not shown) and a return line 44. The mud 38 transports cuttings from the borehole 16, helping maintain the borehole integrity. The solids control system substantially separates the cuttings from the mud 38 at the surface, and may include hardware such as shale shakers, centrifuges, and automated chemical additive systems. A second mud tank 25 contains a second fluid, sometimes called a “sweep” fluid or a mud, with properties that differ from mud 38. During various stages of operation, tank 25 may be coupled with fluid line 22 by mud pump 20 or by another pump (not shown) to inject the sweep fluid into drill string 8 and annular space 40.

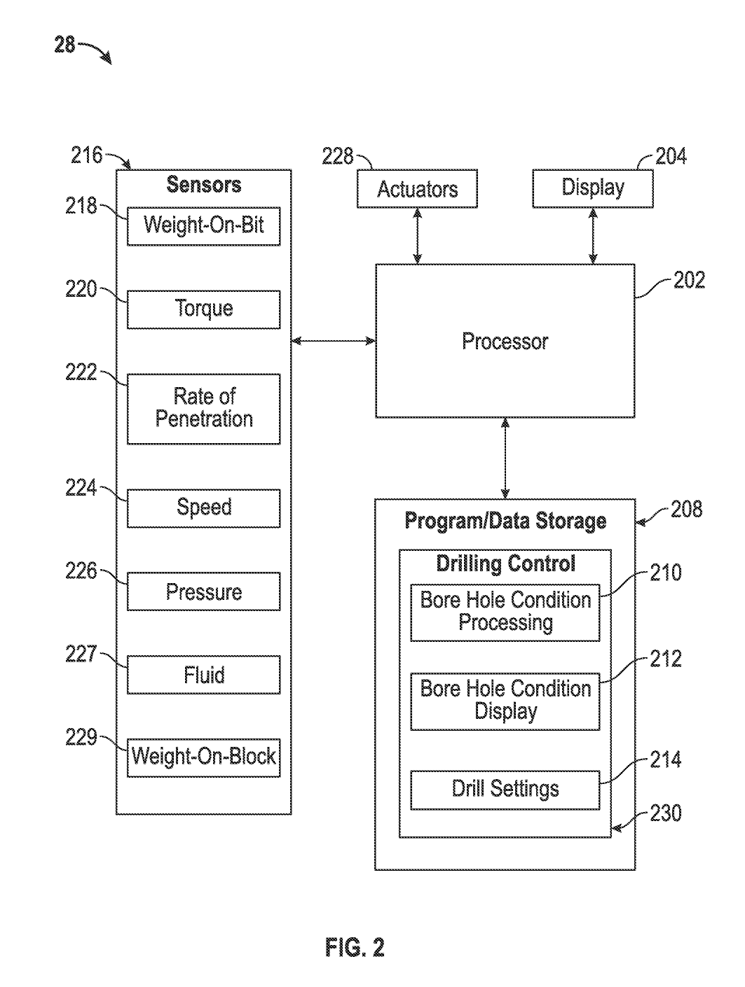

FIG. 2 shows a block diagram of the drilling control system 28, which is configured to evaluate, calculate, and/or control drilling performance and/or borehole condition values, including modified equivalent circulating density, in accordance with principles disclosed herein. The drilling control system 28 includes a processor 202, a display device 204, program/data storage 208, as well as various sensors 216, and actuators 228 (described below) disposed within the drilling system 1. Drilling control system 28 is configured to communicate with and to receive outputs from sensors 216 and to communicate with and to send commands to the actuators 228 via coupling connection 32 that may be wired or wireless. In FIG. 1, connection 32 includes a top-hole repeater unit 102 disposed adjacent kelly 10 or a top-hole drive, or connection 32 includes a transition sub with two communication elements. In some embodiments of the drilling control system 28, the processor 202 and program/data storage 208 may be embodied in computer, such as a desktop computer, notebook computer, a tablet computer, a blade computer, a server computer, a programmable logic controller (PLC), a smart telephone, or other suitable computing device known in the art. In some embodiments, drilling control system 28 is coupled to external computer or communication networks, including the internet (e.g. the world-wide-web) via a wired or wireless coupling, for example antenna 29. The connection may be Ethernet compatible, may use cellular telephonic technology, or may use any other communications technology known in the art.

Referring again to FIG. 2, the various sensors 216 are employed in drilling system 1 for monitoring a variety of drilling operation conditions and borehole conditions and for measuring values corresponding to those conditions. For example, at least one fluid sensor 227 disposed in the fluid line 22 measures and provides information about the drilling fluid flow rate and pressure. At least one torque sensor 220 (e.g., a strain gauge) and at least one rotational speed sensor 224 (e.g., an angular position sensor) coupled to the drill string 8 measure and provide information about the torque applied to the drill string 8 and the rotational speed of the drill string 8, respectively. Additionally, a load sensor 229 (e.g., a strain gauge) associated with traveling block 6 may be used to measure and provide the hook load, comprising the weight and acceleration of the drill string 8. At least one weight-on-bit sensor 218 (e.g., a strain gauge) coupled to the traveling block 6 or disposed in the BHA 42 measures the portion of the weight of the drill string 8 applied to the drill bit 14. Rate of penetration sensors 222 detect the motion of the traveling block 6 and/or the extension of the line supporting the traveling block 6, or other indications of the drill string 8 descending into the borehole 16. In some embodiments, additional sensors 216 monitor the operation of the motor controller of drawworks 36, the operation of the rotary table 12 motor, or another drilling operation condition. These include, but are not limited to, sensors for detecting such operational properties as motor speed (RPM), winding voltage, winding resistance, motor current, and motor temperature. In some embodiments, still other sensors are used to indicate the performance of the solids control system. Data from sensors 216 aid when adjustments are made to the operation of drilling system 1.

Pressure in borehole 16 results at least in part from the presence of drilling mud and/or formation fluids. Among the sensors 216, two or more pressure sensors 226 disposed along drill string 8 are configured to monitor pressure in the borehole 16. Referring again to FIG. 1, four sensors 226 are identified with a subscript. Thus pressure sensors are labeled as 226_1, 226_2, 226_3, 226_4. The subscripts serve to distinguish pressure sensors located at different, known axial locations along drill string 8. Other embodiments may include more or fewer sensors 226. In the example of FIG. 1, bottom hole assembly (BHA) 42 includes a sensor 226_1. Other embodiments may have more or fewer sensors in BHA 42. The three other sensors 226_2, 226_3, 226_4 are disposed at other locations along drill string 8. The bottom hole assembly (BHA) 42 may also include a measurement-while-drilling (MWD) and/or a logging-while-drilling (LWD) assembly containing sensors for determining drilling dynamics, drilling direction, formation properties, borehole condition values, etc. In the embodiments shown, outputs of one or more of the sensors 226 or any other sensor 216 disposed along drill string 8 are transmitted to the surface via wired drill pipe 8. However, one or more of other suitable downhole signal conveyance technologies known in the art may be employed (e.g., mud pulse, fiber-optics, acoustic, electromagnetic hops, etc.).

Referring again to FIG. 2, the actuators 228 include mechanisms and/or interfaces that are controlled by the processor 202 to affect drilling operations. For example, the processor 202 may control rotation speed of the drill string 8 by controlling an electric motor for rotary table 12 through a motor controller. As another example, the processor 202 may similarly control weight-on-bit or the axial position of drill string 8 in borehole 16 by controlling a motor in the drawworks 36. Processor 202 may control the flow rate or pressure of mud 38 by adjusting the motor speed or a pressure setting for mud pump 20. Various other types of actuators controlled by the processor 202 include solenoids, pumps, telemetry transmitters, valves, etc.

The display 204 includes one or more display devices used to convey information to a drilling operator, such as, for example, outputs from a sensor 216, conditions of and commands for an actuator 228, or a calculated value describing a borehole condition at one or more locations along drill string 8 or borehole 16. The display 204 may be implemented using one or more display technology known in that art, such as liquid crystal, cathode ray, plasma, organic light emitting diode, vacuum fluorescent, electroluminescent, electronic paper, a printer that provides a copy of results on a media such as paper, or other display technology suitable for providing information to a user.

The processor 202 is configured to execute instructions retrieved from storage 208. The processor 202 may include any number of cores or sub-processors. Suitable processors include, for example, general-purpose processors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems.

Software programming including instructions executable by the processor 202 is stored in the program/data storage 208. The program/data storage 208 is a computer-readable medium. Computer-readable storage media include volatile storage such as random access memory, non-volatile storage (e.g., ROM, PROM), a hard drive, an optical storage device (e.g., CD or DVD), FLASH storage, or combinations thereof. The program/data storage 208 includes a drilling control module 230 that when executed causes the processor 202 to control drilling operations. The drilling control module 230 includes a borehole condition processing module 210 that includes instructions that when executed cause the processor 202 to collect or calculate at least one borehole condition value based on the measurements provided by at least one of the sensors 216. In at least one embodiment, processor 202 and processing module 210 calculate at least one borehole condition value (e.g. equivalent static density, equivalent circulating density, or modified equivalent circulating density) using current or historic data or using simulated or predicted data. Equations for borehole condition values are presented in a subsequent portion of this document.

For each borehole condition value generated for the borehole 16, the borehole condition processing module 210 may compare one or more other borehole condition value corresponding to data from differing depths in borehole 16 and form a comparative analysis. The borehole condition value or values may be stored local to the processor 202 (e.g., in storage disposed proximate to the drilling system, such as program/data storage 208) or remote from the processor 202 and accessed via a communication network (e.g., the internet).

A borehole condition display module 212 includes instructions that when executed cause the processor 202 to render a display of the borehole condition value or values generated by the borehole condition processing module 212. The borehole condition display module 212 may instruct the processor 202 to present the values via display 204 or via a communication network. The borehole condition display module 212 may render the borehole condition values in graphical or textual form. In some embodiments, the borehole condition values are displayed showing spatial trends (e.g. varying along axis 17) and/or chronological trends and/or are displayed as a numeric value representative of borehole condition at a given depth (e.g., current borehole depth).

A drill settings module 214 includes instructions that when executed cause the processor 202 to manipulate the actuators 228 to control the drilling operation. The drill settings module 214 may also provide a control interface (e.g., via the display 204) and a user input device (e.g., keyboard, mouse, trackball, touchscreen, motion sensors, etc.) that allows a drilling operator to enter drilling control information into the drilling control system 28. For example, the drill settings module 214 may provide a user interface that allows the drilling operator to change controllable parameters such as WOB, drill string RPM, mud density or specific weight, etc. based on one or more borehole condition value provided by processor 202. The density or specific weight of the drilling mud can be influenced by the addition of solids, a fluid additive, or water. In addition, when employing some embodiments, operators make manual changes to one or more aspect of drilling system 1 operation based on one or more borehole condition value. For example, manual changes include altering the density or specific weight of the drilling mud and adding or removing sensors or components on drill string 8. In at least some embodiments, the drill settings module 214 and borehole condition display module 212 in combination with the display 204 constitute a graphical user interface. Based on the functionality of modules 210, 212, 214, borehole condition monitoring instructions are available to processor 202 from drilling control module 230.

### Details Regarding the Calculation of Certain Borehole Condition Values

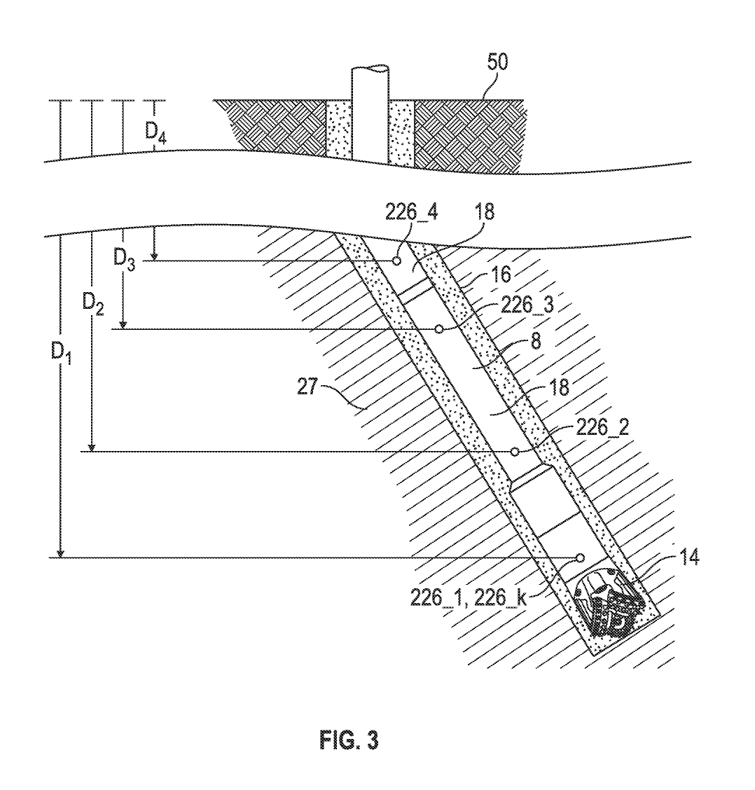

The calculation and evaluation of some borehole condition values, which in at least some embodiments are also controllable drilling parameters, will be discussed in reference to FIG. 3, which shows a portion of drilling system 1 at another stage in the drilling process. As compared to FIG. 1, some components and features have been omitted for clarity. As shown in FIG. 3, the section of drill string 8 that includes sensors 226_1 to 226_4 is disposed in a portion of borehole 16 that is not strictly vertical. In other instances, at least a portion of the section that includes sensors 226_1 to 226_4 is disposed in a vertical portion of borehole 16.

For the mud in a borehole, such as borehole 16, hydrostatic pressure increases proportionally with vertical depth and with mud specific weight. Specific weight is a property describing the weight per unit volume of a substance, and is equivalent to density (mass per unit volume) multiplied by the acceleration due to gravity. Specific weight has the units of Newtons per cubic meter [Nr/m³] or pounds-force per gallon [lb.-f/gal], or another appropriate set of engineering units. Specific weight is symbolized herein by the Greek letter gamma, γ. For drilling mud, specific weight is commonly called “mud weight”; although, the term “density” is also sometimes used. Specific weight of mud within borehole 16 is influenced by and may vary according to at least these factors: (a) changes made to the mud 38 disposed in tank 24, (b) the generation rate of cuttings by drill bit 14, (c) density variations within the subsurface formation being cut (e.g. formation 27), and (d) the drill bit 14 passing from one subsurface formation to another of different density, such as passing from formation 26 to 27, for example, as depicted in FIG. 1. When mud receives and carries cuttings from drill bit 14, the specific weight of the mud in annular space 40 is increased as compared to the specific weight of mud in drill string 8 and mud tank 24. The mud specific weight in annular space 40 may also increase or decrease due to one or more of these and possibly other circumstances: (a) intrusion of formation fluids and (b) the loss of a liquid constituent from the mud to a porous formation.

Pressure sensors 226 disposed on drill string 8 are configured to measure the pressure in borehole 16. When disposed on or near the outer surface of a drill string and activated, a sensor 226 measures the pressure in the mud 38 within the annular space 40. While mud 38 in borehole 16 is not circulating but is static, the hydrostatic pressure, P_{HS}, in borehole 16 may be measured, for example, when mud pump 20 is not active. The hydrostatic pressure measured by any one sensor 226 is proportional to the vertical depth of that sensor 226 and the average specific weight of the mud above that sensor 226. The relationship for hydrostatic pressure, P_{HS}, at a specific location in the borehole is:

P_{HS}=γ*D 1

### Where:

D=the vertical depth at the location corresponding to P_{HS}, also called true vertical depth or simply, “depth.”
γ=average specific weight of the mud above the location for which hydrostatic pressure is measured or evaluated.

FIG. 3 shows four vertical depths D_{I}, D₂, D₃, D₄, corresponding to the position of four sensors 226_1, 226_2, 226_3, 226_4, respectively, capable of measuring the pressure in mud 38. The depth of a sensor 226 is determined by any method known in the art. Embodiments may have more or fewer sensors 226 disposed at more or fewer depths. In addition, some embodiments include positioning more than one sensor 226 at the same depth, for example, positioning a pair of sensors 226 at depth D₂ while depth D₁ has a different number of sensors 226, or positioning three sensors 226 at each of the depths D. While each sensor 226 is capable of measuring hydrostatic pressure, Equation 1 states that hydrostatic pressure, P_{HS}, at the location of sensor 226_1 can be calculated from known or estimated values of mud specific weight and the corresponding depth D₁. Similarly, hydrostatic pressure can be calculated for any known depth if mud specific weight is known or estimated. As with all variables, parameters, properties, and equations used herein, any set of appropriate and consistent set of engineering units known in the art may be applied. For some sets of units, additional conversion factors may be required to achieve or to maintain consistency.

The term equivalent static density (ESD) is used in the industry to refer to the average specific weight of the mud and, more particularly, to refer to the average specific weight of the mud disposed above a particular location in a borehole, such as location D₁ in borehole 316, for example. Therefore, equivalent static density is simply:

ESD=γ 2

Equivalent static density is used in the industry as an expression of normalized downhole pressure from various depths when the drilling mud is not being pumped, i.e. is static. In general, ESD of Equation 2 is substituted into Equation 1 to yield:

P_{HS}=ESD*D 3

For mud 38 in tank 24, specific weight or ESD can be determined by the operators before the mud enters the borehole. For mud 38 in borehole 16, which in some situations includes recently accumulated cuttings, ESD may be calculated from measurements. By rearranging Equation 3, ESD may be calculated from hydrostatic pressure and depth:

$$E S D = \frac{{P}_{HS}}{D} \qquad 4$$

As stated in Equation 4, equivalent static density is directly proportional to hydrostatic pressure and inversely proportional to depth. Other methods may be used to evaluate or calculate ESD.

In one drilling scenario, the mud may steadily collect cuttings from a single rock formation at a substantially uniform rate, and this mixture of mud and cuttings will travel upwards, displacing all mud previously disposed in the annular space 40 of borehole 16. Consequently, the annular space 40 will be filled axially with a generally uniform mixture of drilling mud and cuttings, and the equivalent static density calculated for any depth will be constant.

In another scenario, the ESD varies according to the amount of one or more constituents in the mud, as explained in relationship to mud specific weight. If, for example, the pumping of mud 38 starts and stops between periods of drilling in order to obtain sequential measurements of hydrostatic pressure, and if the rate of penetration or the density of the formation changes, then equivalent static density can vary over time and can vary as to location along axes 9, 17. This variation in ESD will be observed by sensors 226 along drill string 8 and may be correlated to specific locations along the length (i.e. axis 17) and depth of borehole 16.

While drilling mud is pumped into borehole 16, the downhole pressure increases as the mud pump 20 works to overcome frictional losses as mud 38 flows through the center of drill string 8, exits drill bit 14, and returns axially through borehole annular space 40, possibly with the addition of cuttings. Sensor 227 located near the discharge of the mud pump 20 measures the entire frictional pressure drop due to mud traveling through fluid line 22, through drill string 8, up annular space 40, back to the earth's surface 50. Additional frictional losses may be sensed by sensor 227 depending on the flow path required to reach the solids control system or mud tank 24. Due to its location above earth's surface 50, as shown in FIG. 1, sensor 227 measures substantially no hydrostatic pressure associate with the borehole. Each pressure sensor 226 disposed on drill string 8 within borehole 16 will sense the local hydrostatic pressure plus the increase pressure that is required to overcome the frictional losses that occur beyond the sensor 226. For example, sensor 226_2 will sense the hydrostatic pressure corresponding to its depth, D₂, plus a dynamic pressure contribution required to overcome the frictional losses in the portion of annular space 40 located between sensor 226_2 and the earth's surface 50. Additional frictional losses may be sensed by sensor 226_2 depending on the flow path required to reach the solids control system or mud tank 24. Thus, in general, the pressure collected or measured for a location in a borehole, for example at the location of sensor 226_2 disposed within borehole 16, comprises at least two components:

P=P_{HS}+P_{dyn} 5

### Where:

P=downhole pressure
P_{HS}=hydrostatic component of pressure, P
P_{dyn}=dynamic component of pressure, P, required to overcome frictional losses due to mud 38 flow in the borehole 16

Equivalent circulating density (ECD) is an industry convention for normalizing downhole pressure data, particularly while pumping drilling mud. Equivalent circulating density is used to compare multiple pressure data from one or more sensors at various locations in a borehole. Using conventional techniques, equivalent circulating density is calculated as pressure divided by the depth at the location of the pressure measurement. The formula for calculating equivalent circulating density is similar to that for calculating equivalent static density:

$$E C D = \frac{P}{D} \qquad 6$$

With Equation 5 Substituted into Equation 6:

$$E C D = \frac{{P}_{HS} + {P}_{dyn}}{D} \qquad 7$$

An application of Equation 4 yields a relationship between equivalent circulating density and equivalent static density:

$$E C D = E S D + \frac{{P}_{dyn}}{D} \qquad 8$$

Thus, as stated in Equation 8, when evaluating data corresponding to static, i.e. non-circulating, drilling mud, then equivalent circulating density (ECD) equals equivalent static density (ESD). Depending on the amount of information desired, ECD may be calculated according to Equation 8 once or may be calculated a multiple of times for a borehole. As shown here, the formula of Equation 8 can be written with subscripts to distinguish the individual data and the results derived from the various sensors 226_i:

$$E C {D}_{i} = E S {D}_{i} + \frac{{P}_{dyn , i}}{{D}_{i}} \qquad 9$$

### Where:

i=index of integer numbers referring to an individual pressure sensor, where i=1 . . . iₘₐₓ, and, preferably, iₘₐₓ=2 or greater.

The data for Equation 9 can be measured using one or more sensors 226 axially displaced along the outer surface of drill string 8. This type of configuration is shown in FIG. 3. As used herein, the subscript “i” refers to an individual sensor 226_i located at a particular axial location along drill string 8, and likewise, the subscript “i” refers to data associated with the sensor 226_i. Multiple groups of data may be collected over a sequence of time. During data collection, drill string 8 and components attached to it, such as sensors 226, move due to vibration, rotation, drill bit penetration, fluid interaction, and other factors. Thus, data and results of Equation 9 may differ according to these and other factors in addition to differing by axial displacement. The data and results of other subscripted equations in this document can also vary in a similar manner.

Changes in mud flow conditions influence the calculation of equivalent circulating density. Even with steady mud flow conditions, values of equivalent circulating density evaluated by Equation 9 may vary appreciably, due at least in part to inadequate scaling, which is accomplished by the use of a single scaling factor, namely the depth, Dᵢ, of sensor 226_i.

A method for measuring and calculating borehole conditions, implements a new variable with similarities to but distinct from the equivalent circulating density of Equation 9. This new variable, called modified equivalent circulating density, ECDm, is evaluated by the following formula using data corresponding to a sensor 226_i:

$$E C D {m}_{i} = \frac{{P}_{HS , i}}{{D}_{i}} + \frac{{P}_{dyn , i}}{{D}_{k}} \qquad 10$$

### Where:

i=index of integer numbers referring to an individual pressure sensor, where i=1 . . . iₘₐₓ, and, preferably, iₘₐₓ=2 or greater.
k=index of integer numbers referring to a single pressure sensor, where 1≦k≦iₘₐₓ.
Dᵢ=depth at a particular location “i”
Dₖ=depth at the particular location “k”

In at least one embodiment, the selected value of true vertical depth Dₖ corresponds to a fixed location along borehole 16 or to a location along drill string 8 other than the location of a sensor 226_i. In at least a second embodiment, an embodiment wherein iₘₐₓ equals 2 or greater, the subscript “k” refers to data associated with a single sensor 226_k located at a particular axial location along drilling string 8. For the sake of discussion, this second embodiment will be used to describe further the method for evaluating modified ECD. The value of the subscript k can be selected to equal any one value from among the possible values of subscript i. For example, in FIG. 3 sensor 226_1 has been selected by a user or by control system 28 to be the sensor 226_k. In that example, and Dₖ=D₁, and sensor 226_k is located in the Bottom Hole Assembly (BHA) 42 in proximity to drill bit 14.

Modified ECD may be calculated according to Equation 10 or any similar equation once or calculated multiple times for a borehole, such as borehole 16. The method(s) for modified ECDm disclosed herein includes provisions for collecting data in a substantially simultaneous matter and for collecting data at different times or in sequential time intervals. As used herein and in the claims, the term a “substantially simultaneous manner” means that an activity, such as data collection for example, occurs during a period of time equal to or less than sixty seconds. In some instances, at least some of the data measurements for modified ECD are collected over a period of time longer than sixty seconds.

Reference is given to Equation 5 wherein a collected or measured pressure comprises a hydrostatic component and a dynamic component. So too, modified ECD has a hydrostatic pressure component, which is the first term on the right side of Equation 10, and a dynamic pressure component, which is the second term on the right side of Equation 10. As shown in Equation 10, the formulation of the modified ECD applies a different scaling factor to the dynamic component of the downhole pressure as compared to the hydrostatic component of the downhole pressure. As in Equations 4 and 7, the hydrostatic pressure in Equation 10 is scaled by the depth, Dᵢ, corresponding to the location of the sensor 226_i that measures the pressure. However, distinct from Equations 6 through 9, the dynamic pressure in Equation 10 is scaled by the previously defined depth Dₖ. Substituting Equation 4 into Equation 10 illustrates the relationship between modified equivalent circulating density, ECDm, and equivalent static density, ESD.

$$E C D {m}_{i} = E S {D}_{i} + \frac{{P}_{dyn , i}}{{D}_{k}} \qquad 11$$

It will be observed that when evaluating Equation 11 to yield ECDmₖ for the one sensor 226_k, the value of subscript i is identical to k. Thus, the two values of depth, i.e. Dᵢ and Dₖ will be equal, causing the result of Equation 11 to match the result of Equation 9. When evaluating Equation 11 to yield ECDmᵢ for any sensor 226_i other than sensor 226_k, the subscripts are not equal, i≠k, and Equations 9 and 11 yield different results.

Applying Equation 5 for downhole pressure for sensor 226_i, Equation 11 transforms to:

$$E C D {m}_{i} = E S {D}_{i} + \frac{{P}_{i} - {P}_{HS , i}}{{D}_{k}} \qquad 12$$

With another application of Equation 4 or, equivalently, Equation 3 and further rearrangement, the formula for modified equivalent circulating density becomes:

$$\begin{matrix}E C D {m}_{i} = E S {D}_{i} + \frac{{P}_{i} - E S {D}_{i} \cdot {D}_{i}}{{D}_{k}} & 13 \\ E C D {m}_{i} = E S {D}_{i} + [ 1 - \frac{{D}_{i}}{{D}_{k}} ] + \frac{{P}_{i}}{{D}_{k}} & 14\end{matrix}$$

Alternatively, proceeding in a different order of steps but forming an equivalent expression, Equation 10 can be simplified with the direct substitution of Equation 5 for dynamic pressure:

$$E C D {m}_{i} = \frac{{P}_{HS , i}}{{D}_{i}} + \frac{{P}_{i} - {P}_{HS , i}}{{D}_{k}} \qquad 15$$

which, when rearranged, becomes:

$$E C D {m}_{i} = {P}_{HS , i} [ \frac{1}{{D}_{i}} - \frac{1}{{D}_{k}} ] + \frac{{P}_{i}}{{D}_{k}} \qquad 16$$

Equations 10-16 are mathematically equivalent expressions for modified equivalent circulating density. Equation 14 presents modified ECD in terms of equivalent static density. Equation 16 presents modified ECD in terms of hydrostatic pressure. At least equations 14 and 16 are written in terms of measureable quantities or quantities that can be derived from measureable quantities. When calculating modified equivalent circulating density using some sets of units, a conversion factor may be applied in order to achieve or to maintain unit consistency.

During a drilling operation, as the drill bit 14 penetrates further into formation 26, pressure sensors 226 along the drill string 8 move further into the extending borehole 16. The location of a sensor 226_k changes, causing its depth, Dₖ, to change unless passing through a horizontal portion of the borehole. Even so, when a set of data including data from more than one sensor 226_i is collected in a substantially simultaneous manner or in close chronological succession, a fixed value of Dₖ is used to evaluate the modified equivalent circulating density, ECDmᵢ, for all sensors 226_i. For the data set, the fixed value of Dₖ is used even though sensor 226_k potentially moves some vertical distance during the collection of the data. This vertical distance that sensor 226_k moves during the collection of a substantially simultaneous data set is anticipated to be short relative to the average distance between adjacent pairs of sensors 226 or very short relative to the length of the borehole 16. The use of single, fixed value of Dₖ to scale the dynamic component of the pressure allows a better comparison of pressure data collected at different locations along the borehole. In some embodiments and some applications of the method, the result will be a constant or nearly constant value for multiple ECDm; along the borehole. That is to say, for a substantially simultaneous data set, a possible result is:

ECDmᵢ=ECDm₁=ECDm₂= . . . =ECDmₖ= . . . 17

As in the other equations herein, the equal sign (=) in Equation 17 should be interpreted as defining a theoretical equality. However, the actual, real-world results from the equations will be influenced by factors that are not accounted, including experimental error. These unaccounted factors often cause expressions on opposite sides of the equation not to be precisely equal. For example, in some scenarios, individual values of ECDmᵢ will be influenced by cutting density variations, by formation interactions, or by variations in another influential factor, any of which may vary along the centerline 17 of borehole 16. When a new data set is collected, a new value of Dₖ is collected and used. In other instances, the value of Dₖ is preserved and reused between two or more separate data sets. The previous description does not preclude the option of using a single value of Dₖ for other data sets, such as those that are not collected in a substantially simultaneous manner.

The result of each or any of the equations disclosed herein is a borehole condition value or result and may be collected or calculated by processor 202, presented on display 204, and/or stored according to the instructions in program/data storage 208 (FIG. 2). In particular, modified equivalent circulating density, ECDm, of Equations 10, 14, 16 is a borehole condition value calculated by processor 202. Optionally, data is provided to, delivered to, or generated by an external computer, and modified ECD is calculated by and/or stored within the external computer.

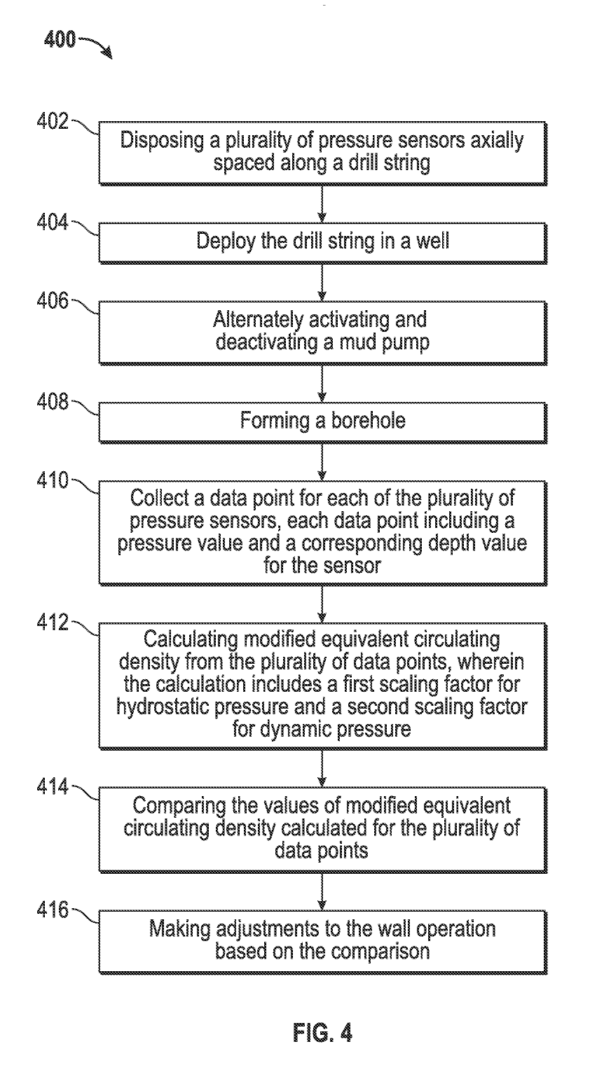

Referring to FIG. 4, method 400 is an embodiment of a method for measuring and calculating modified equivalent circulating density (ECDm). Method 400 may be applied while drilling or while performing other downhole operations such as, for example, reaming, circulating, and responding to a stuck pipe. Method 400 comprises step 402, which includes disposing a plurality of pressure sensors axially spaced along a drill string, for example disposing sensors 226 on drill string 8. Step 404 involves deploying the drill string in a well operation. The method continues by activating a mud pump at step 406 and forming a borehole at step 408. Steps 404, 406, 408 are exemplified by the deployment of drill string 8 and mud pump 20 to form borehole 16 in FIGS. 1 and 3. Step 410 comprises collecting a data point for each of the plurality of pressure sensors. Each data point includes a value of the downhole pressure and a corresponding value of the depth for the pressure sensor. In at least some instances, the collected data point for each pressure sensor also includes a value of hydrostatic pressure generally corresponding to the location of the sensor. In step 412, modified equivalent circulating density (ECDm) is calculated for one or more of the plurality of data points associated with the plurality of pressure sensors, such as the multiple sensors 226_i shown in FIG. 3, where i=1, 2, 3, and 4. In this case, iₘₐₓ equals the value of four. In other instanced iₘₐₓ will be more or less than four. Preferably, iₘₐₓ has a value equal to or greater than two. ECDm is calculated using the equivalence of an Equation 10, 14, 16. As presented concisely in Equation 10, the calculation includes a first scaling factor for hydrostatic pressure and a second scaling factor for dynamic pressure. For each value of ECDmᵢ, corresponding to a particular sensor 226_i, the first scaling factor is the depth, Dᵢ, of the sensor 226_i. The second scaling factor is the selected depth, Dₖ, corresponding to the location of a selected sensor 226_k or corresponding to another location along drill string 8 or a location along borehole 16, as previously explained. In the example of FIG. 3, sensor 226_1 disposed in the Bottom Hole Assembly (BHA) 42 corresponds to the selection of sensor 226_k. With these considerations, the calculation of ECDm involves calculating hydrostatic pressure component and a dynamic pressure component. The dynamic pressure component of ECDm is the second term on the right side of Equation 10 but is dispersed among the multiple terms of Equations 14 and 16, as examples.

Referring still to FIG. 4, method 400 continues at step 414 by comparing the multiple values of modified equivalent circulating density calculated for the multiple pressure sensors. Step 416 involves making adjustments to the well operation based on the comparison of the multiple values of modified equivalent circulating density. Possible adjustments include, for example, changing the specific weight of mud 38, changing the speed of mud pump 20, and adjusting one or more of the actuators 228 while monitoring a response involving one or more sensors 216, including sensors 226. For example, possible adjustments include increasing (or decreasing) the rotation rate of drill string 8 to while monitoring speed sensor 224 and increasing the weight-on-bit while monitoring sensor 218. These changes which may influence the removal of cuttings or the rate of penetration through formation 27. Possible adjustments also include performing a “sweep operation” by pumping a different fluid from another tank, such as second mud tank 25, into drill string 8 and borehole 16. In addition, a “kill operation may be performed during step 416 based on data from one of the other steps. A kill operation involves pumping a mud with a very high specific weight onto a well, e.g. borehole 16, to overcome the intrusion of formation fluids. Method 400 may be repeated at various or periodic times to monitor or control the performance of drilling system, such as drilling system 1.

For the embodiment of FIG. 2, collected data and modified ECD values from Method 400 are held in storage (e.g. computer memory) within or coupled to processor 202 such as program/data storage 208 and are evaluated by processor 202. In some embodiments, the data and/or modified ECD values are calculated and/or stored in a computer or a calculator disposed external to drilling control system 28.

Method 400 allows for flexibility. For example, one or more portions of method 400, for example calculating modified ECD, may be performed after other well operations are paused or have ceased or may be performed with historic or estimated data before other well operations have begun. Furthermore, the sequence of two or more blocks or operations steps of method 400 might be rearranged in some embodiments. Other embodiments of method 400 include additional operations, such as calculating the equivalent circulating density of Equation 9 for comparison against the results of an equation 10, 14, 16. Various embodiments may exclude one or more of the operations listed in FIG. 4, provided that modified equivalent circulating density is evaluated or the dynamic pressure component of ECDm is evaluated. In some incidences, step 414 is augmented by or replaced by comparing multiple values of the dynamic pressure component of ECDm for multiple sensors 226.

### Additional Information

In some embodiments, two or more co-located pressure sensors 226 are disposed at one location, i, along drill string 8 where pressure data can be collected. The multiple, co-located pressure sensors 226 are circumferentially spaced around drill string 8 or are disposed in close proximity to each other. In some of these embodiments, more than one location, i, has co-located pressure sensors 226. The data from the multiple pressure sensors 226 at the location, i, is used to evaluate modified equivalent circulating density, ECDmᵢ, using any of the appropriate equations presented herein. In one or more embodiments of the method, the data from the described multiple, co-located pressure sensors 226 are averaged, and the averaged pressure value is retained and used to calculate modified equivalent circulating density. In other embodiments, multiple values of modified equivalent circulating density are calculated for each location, i, and then averaged for that location. In still other embodiments, the multiple data and results for the at least one location, i, are collected and evaluated individually without averaging.

To improve the evaluation of a result, the method for evaluating modified ECD optionally includes performing a data filter on the collected or measured pressure data. In some embodiments, the data filter is a tracking filter or an optimal sequential filter, such as a Kalman filter or an extended Kalman filter, as known in the art. In one implementation, multiple data from a given pressure sensor 226, such as sensor 226_2 for example, are collected and passed through the filter. The process is repeated for each sensor 226. From the filtering process, a resulting pressure data is retained for the given sensor 226_2 and is applied to calculate the dynamic pressure component of modified ECD and/or modified ECD as a whole. In some of these embodiments, the filter is implemented as instructions in borehole condition processing module 210. In some of these embodiments, the filtering instructions are configured to include additional data from another sensor 216 that provides values indicative of a drilling operation condition. Rotational speed sensor 224 is an example. The additional data is sent so that some drilling equipment activity is factored into or influences the filtering methodology to account for operations-induced downhole pressure changes, in contrast to pressure effects coming from a formation 26, 27. Rotary table 12, a top-drive, and drawworks 36 are examples of equipment that can influence downhole pressure. Although, described in terms of filtering performed by processor 202, data filtering may, in addition or instead, be performed in an external computer.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, additional mathematically equivalent expressions for modified equivalent circulating density (ECDm) may be developed, or other applications of ECDm may be implemented. Accordingly, the scope of protection is not limited to the embodiments described herein, but is only limited by the claims that follow, the scope of which shall include all equivalents of the subject matter of the claims.

1. A method for collecting and analyzing downhole pressure data, comprising:
collecting a first data set comprising a data point for each of a plurality of pressure sensors, the sensors positioned at axially spaced locations along a drill string deployed in a well, each data point comprising a retained pressure value and a corresponding depth value;
calculating a value of modified equivalent circulating density (ECDm) for at least one of the data points, the ECDm comprising a static pressure component and a dynamic pressure component, wherein the calculating comprises:
computing the static pressure component of the ECDm based on a first depth value; and
computing the dynamic pressure component of the ECDm based on a selected depth value that differs from the first depth value.

2. The method of claim 1 further comprising:
comparing the values of ECDm calculated for at least two data points.

3. The method of claim 2 further comprising:
making adjustments to the well operation based on a result derived from the comparing.

4. The method of claim 1 wherein calculating comprises summing the static pressure component and the dynamic pressure component for the value of ECDm.

5. The method of claim 1 wherein the first depth value is a depth of a first of the pressure sensors and the second depth value is a depth of a second of the sensors.

6. The method of claim 1 wherein the same selected depth value is applied to calculate a value of ECDm for each of the data points.

7. The method of claim 1 wherein collecting a data point for each of the plurality of pressure sensors occurs substantially simultaneously.

8. The method of claim 1 further comprising
collecting a second data set comprising a data point for each of the plurality of pressure sensors, each data point comprising a retained pressure value and a corresponding depth value;
calculating a value of ECDm for each of the data points of the second data set;
comparing the values of ECDm for the first data set with the values of ECDm for the second data set; and
making adjustments to the well operation based on a result of the comparing.

9. The method of claim 1 further comprising:
collecting a data point for each of a plurality of co-located pressure sensors at a same axial displacement along the drill string, the axial displacement corresponding to one of the locations, each data point comprising a pressure value and a corresponding depth value; and
one of:
assigning an average of the co-located pressure values to be the retained pressure value of a data point of the first set; and
assigning an average of ECDm values calculated for the co-located pressure sensors to be an ECDm value for a data point of the first set; wherein each ECDm value for the co-located pressure sensors is computed based on a static pressure scaling factor corresponding to a first depth and a dynamic pressure scaling factor corresponding to a selected depth that is different from the first depth.

10. The method of claim 1, wherein the collecting comprises at least one of:
measuring, calculating, or estimating pressure proximate to each pressure sensor; and
measuring, calculating, or estimating depth corresponding to each pressure sensor.

11. The method of claim 1 further comprising:
collecting a plurality of intermediate data points for each pressure sensor, each intermediate data point comprising a pressure value and a corresponding depth value; and
performing a data filter on the plurality of data points and the assigning filtered result to be the retained pressure value of a data point of the first set.

12. The method of claim 11 further comprises
Collecting operational data comprising at least one drilling operation condition value from a sensor monitoring said conditions; and
wherein performing a data filter further results in the operational data influencing the calculating of at least one component of modified ECDm.

13. A system for analyzing downhole pressure, comprising:
a drill string comprising:
a plurality of joints of wired drill pipe arranged end-to-end;
a plurality of pressure sensors at a plurality of locations spaced along the joints of drill pipe; and
a drilling control system coupled to the pressure sensors via the wired joints of drill pipe, the drilling control system configured to:
acquire for each of the locations a first measurement of borehole pressure from the pressure sensor at the location and a first depth value corresponding to the depth of the first measurement of the borehole pressure;
compute a first dynamic pressure component of modified equivalent circulating density (ECDm) for each of the locations based on a same depth value; and
compute a first ECDm value for each of the locations based on the first dynamic pressure component computed for the pressure sensor.

14. The system of claim 13, wherein the drilling control system is configured to:
compute a static pressure component of ECDm for each of the locations based on the first depth value corresponding to the depth of the first measurement; and
compute the first ECDm value for each of the locations by combining the first dynamic pressure component and the static pressure component computed for the location.

15. The system of claim 13, wherein the drilling control system is configured to:
compare the first ECDm values computed for different locations; and
make adjustments to a well operation based on a result of the comparison.

16. The system of claim 13, wherein the drilling control system is configured to:
compare the first dynamic pressure component of ECDm computed for different locations; and
make adjustments to a well operation based on a result of the comparison.

17. The system of claim 13, wherein the same depth value is a first depth value corresponding to the depth of a first measurement of the borehole pressure of one of the locations.

18. The system of claim 13, wherein the drilling control system is configured to:
acquire for each of the locations a second measurement of borehole pressure from the pressure sensor at the location and a second depth value corresponding to the depth of the second measurement of the borehole pressure;
compute a second dynamic pressure component of ECDm for each of the locations based on a single depth value;
compute a second ECDm value for each of the locations based on the second dynamic pressure component computed for the pressure sensor;
compare at least one of the first ECDm values with at least one of the second ECDm values; and
make adjustments to a well operation based on a result of the comparison.

19. The system of claim 13, wherein the drilling control system is configured to:
acquire for each of the locations a second measurement of borehole pressure from the pressure sensor at the location and a second depth value corresponding to the depth of the second measurement of the borehole pressure;
compute a second dynamic pressure component of ECDm for each of the locations based on a single depth value;
compare at least one first dynamic pressure component of ECDm with at least one second dynamic pressure component of ECDm; and
make adjustments to a well operation based on a result of the comparison.

20. The system of claim 13, further comprising:
a plurality of co-located pressure sensors at a same location along the joints of drill pipe;
wherein the same location corresponds to one of the plurality of locations; and
wherein the drilling control system is configured to:
acquire a measurement of borehole pressure from each of the co-located pressure sensors; and
compute an average of the measurement of borehole pressure from each of the co-located pressure sensors; and
assign the average to be the first measurement of borehole pressure for the corresponding location along the joints of drill pipe.

21. The system of claim 13 further comprising:
a plurality of co-located pressure sensors at a same location along the joints of drill pipe;
wherein the same location corresponds to one of the plurality of locations; and
wherein the drilling control system is configured to:
acquire a measurement of borehole pressure from each of the co-located pressure sensors; and
compute a dynamic pressure component of ECDm for each of the co-located pressure sensors based on a single depth value;
compute a modified ECDm value for each of the co-located pressure sensors based on the first dynamic pressure component computed for the sensor;
compute an average of the ECDm values for the co-located pressure sensors; and
assign the average to be the first ECDm value for the corresponding location along the joints of drill pipe.

22. Apparatus for monitoring borehole pressure, comprising:
a plurality of pressure sensors positioned at a plurality of locations along a length of a wired tubular system for measuring borehole annular pressure;
a processor coupled to the wired tubular system for communication with the pressure sensors; and
borehole condition monitoring instructions that, when executed by the processor, cause the processor to:
compute a static pressure component for each of the locations based on a pressure value from the pressure sensor at the location and a first depth value corresponding to the location;
compute a dynamic pressure component for each of the locations based on a pressure value corresponding to the location and a same depth value applied to all of the dynamic pressure components; and
compute a first modified equivalent circulating density (ECDm) value for each of the locations comprising a summation of the static pressure component and the dynamic pressure component corresponding to the location.

23. The apparatus of claim 22, wherein for at least one of the locations the first depth value corresponding to the location is different from the same depth value applied to all of the dynamic pressure components.

24. The apparatus of claim 22, wherein the borehole condition monitoring instructions cause the processor to:
compare the first ECDm values computed for different ones of the locations; and
make adjustments to operations in the borehole based on a result of the comparison.

25. The apparatus of claim 22, wherein the same depth value applied to all of the dynamic pressure components is a depth value corresponding to one of the plurality of locations.

26. The apparatus of claim 22, wherein the borehole condition monitoring instructions cause the processor to:
compute additional ECDm values for each of the locations as depth of the locations change;
compare the first ECDm values with the additional ECDm values; and
make adjustments to operations in the borehole based on a result of the comparison.

27. The apparatus of claim 22, further comprising:
a plurality of co-located pressure sensors grouped at a given location along the wired tubular system;
wherein the borehole condition monitoring instructions cause the processor to:
compute an average of pressure values measured by the co-located pressure sensors at a given depth, and apply the average to compute the first ECDm value for the location of the co-located pressure sensors; or
compute an average of ECDm values computed for each of the co-located pressure sensors, the average serving as the first ECDm value for the location of the co-located pressure sensors.

28. A non-transitory, computer-readable storage device storing software that, when executed by a processor, causes the processor to:
acquire a plurality of data points, each data point corresponding to a location in a borehole and each data point comprising a pressure value and a corresponding depth value; and
compute a dynamic pressure component of modified equivalent circulating density (ECDm) for each of the data points based on a selected depth value.

29. The non-transitory, computer-readable storage device of claim 28 wherein the software, further causes the processor to:
compute a static pressure component of ECDm for each of the data points wherein the static pressure component is based on the depth value of the data point; and
compute an ECDm value for each of the pressure sensors by combining the dynamic pressure component and the static pressure component computed for the data point.

30. The non-transitory, computer-readable storage device of claim 28 wherein the software, further causes the processor to perform one of the following:
compare the dynamic pressure component of ECDm computed for at least two of the data points; and
compare the ECDm values computed for at least two of the data points.

31. The non-transitory, computer-readable storage device storing software of claim 28, wherein the selected depth value is a depth value corresponding to one of the data points.
